(19) United States
(12) Patent Application Publication
(10) Pub. No.: US 2001/0004603 A1
(43) Pub. Date: Jun. 21, 2001

(54) Communication handset

(76) Inventors: Kari-Pekka Heikkinen, Oulu (FI); Jarkko Jokelainen, Oulu (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/739,102

(22) Filed: Dec. 19, 2000

(30) Foreign Application Priority Data
Dec. 21, 1999 (GB) 9930245.7

(51) Int. Cl. H04Q 7/20

(52) U.S. Cl. 455/556; 455/422

(57) ABSTRACT

A communication handset comprising a receiver for receiving a RF signal incorporating reference altitude and associated atmospheric pressure data; a pressure sensor for measuring atmospheric pressure and processing means for determining from the received atmospheric pressure data and measured atmospheric pressure the difference in altitude between the handset and the reference altitude.

### BACKGROUND OF THE INVENTION

This invention relates to a communication handset, in particular a communication handset for determining the difference in altitude between the handset and a reference altitude.

With the increasing popularity of portable communication handsets, for example radiotelephones, manufactures of the handsets are beginning to incorporate into the handset, in addition to the basic communication apparatus, value-added features such as calculators and video games.

A value-added feature that has been proposed for radiotelphones intended for use in open areas of varying terrain, by for example ramblers and orienteers, is an altimeter.

An altimeter has altitude measuring means which typically comprises a pressure sensor for measuring the atmospheric pressure and a processor for calculating the altitude. The altitude of the radiotelephone is calculated using the atmospheric pressure measured by the pressure sensor in conjunction with reference pressure data stored in the altimeter, where the stored reference data corresponds to the atmospheric pressure at a known altitude.

However, as the weather changes the atmospheric pressure at a given altitude will vary. Therefore, to ensure the altimeter provides accurate altitude information it is necessary to recalibrate the altimeter whenever there is a change in the weather, which requires the altimeter to measure the atmospheric pressure when located at a known altitude.

This may not, however, always be possible when, for example, the user is in an unpopulated area and a weather change occurs, which may be exactly when the user is most likely to require accurate altitude information.

It is desirable to improve this situation.

### SUMMARY OF THE INVENTION

In accordance with a first aspect of the present invention there is provided a communication handset comprising a receiver for receiving a RF signal incorporating reference altitude and associated atmospheric pressure data; a pressure sensor for measuring atmospheric pressure and processing means for determining from the received atmospheric pressure data and measured atmospheric pressure the difference in altitude between the handset and the reference altitude.

This has the advantage of allowing a communication handset to measure the altitude without the need to recalibrate the altitude measuring means whenever a change in weather occurs.

Preferably the communication handset further comprises means for requesting the reference altitude and associated atmospheric data.

This allows the user to obtain updated altitude information whenever the user wants to perform an altitude measurement.

In accordance with a second aspect of the present invention there is provided a cellular communication system comprising a transmitter for transmitting reference altitude and associated atmospheric pressure data and a communication handset comprising a receiver for receiving a RF signal incorporating reference altitude and associated atmospheric pressure data; a pressure sensor for measuring atmospheric pressure and processing means for determining from the received atmospheric pressure data and measured atmospheric pressure the difference in altitude between the handset and the reference altitude.

As the weather conditions within a communication cell will typically be the same this avoids the need to calibrate a handset which is operating within the communication cell.

Preferably the transmitter is a communication handset at a known altitude with a pressure sensor for measuring atmospheric pressure.

Preferably the transmitter is a basestation at a known altitude with a pressure sensor for measuring atmospheric pressure.

### BRIEF DESCRIPTION OF THE DRAWINGS

For a better understanding of the present invention and to understand how the same may be brought into effect reference will now be made, by way of example only, to the accompanying drawings, in which:

FIG. 1 shows a schematic block diagram of a radiotelephone according to an embodiment of the present invention;

FIG. 2 shows a circuit representation of a pressure sensor incorporated in a radiotelephone according to the present invention;

FIG. 3 shows a cellular communication system according to an embodiment of the present invention;

FIG. 4 shows a cellular communication system according to an embodiment of the present invention.

### DETAILED DESCRIPTION OF THE INVENTION

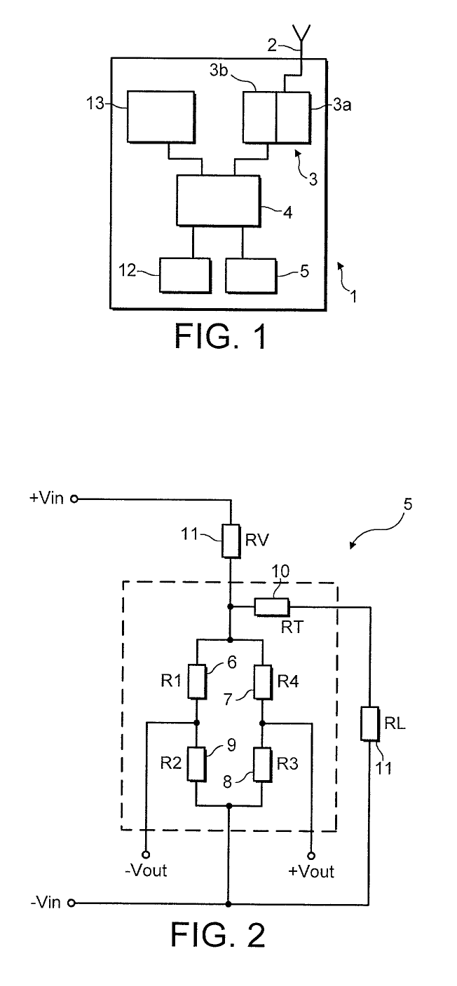

FIG. 1 shows a radiotelephone 1 suitable for use in a cellular communication system, for example GSM.

The radiotelephone 1 has an antenna 2 for receiving and transmitting RF signals from/to a basestation (not shown). The data structure of the RF signal (e.g. the logical/physical channel arrangement and the slot/frame sizes) is as defined in the GSM standard.

The antenna 2 is connected to an input of a transceiver 3. The transceiver 3 comprises a transmitter 3a and a receiver 3b. The transmitter 3a converts a baseband signal generated within the radiotelephone 1 into a RF signal for transmission via antenna 2. The receiver 3b receives a RF signal transmitted to the radiotelephone 1 and converts the RF signal into a baseband signal.

The transceiver 3 is coupled to a processor 4. The processor 4 controls the operation of the radiotelephone 1 and processes control data received and transmitted to/from the radiotelephone 1.

Additionally the radiotelephone 1 has a pressure sensor 5. An output from the pressure sensor 5 is coupled to an input on the processor 4. The pressure sensor 5 is a transducer that converts a pressure measurement into an electrical signal suitable for processing by the processor 4. Preferably the pressure sensor 5 is manufactured from semi-conductor technology. This has various advantages over conventional resistant strain pressure gauges, such as greater sensitivity, high linearity, very low pressure and temperature hysteresis, high reliability, fast response and is small in size.

FIG. 2 shows a circuit representation of the pressure sensor 5. Resistors 6, 7, 8, 9 are pressure sensitive resistors connected as a wheatstone bridge. Resistor 10 is a temperature dependent resistor that is used to compensate for temperature drift of the pressure sensor. Resistors 11 are external resistors for temperature compensation purposes.

The radiotelephone 1 also includes input means 12, for example a keypad and/or microphone, to allow data to be input into the radiotelephone 1. An output from the input means 12 is coupled to an input on the processor 4.

Also coupled to the processor 4 is a display 13. The display 13 is used to displaying information to a user.

In operation the radiotelephone 1 receives a RF signal containing reference altitude and associated atmospheric pressure data (i.e. the atmospheric pressure at the reference altitude). On receipt of the reference data the reference data is passed to the processor 4.

The pressure sensor 5 measures the atmospheric pressure at the altitude of the radiotelephone 1. The measured pressure information is passed to the processor 4 in the form of an electrical signal.

Using the reference altitude and associated atmospheric pressure data with the measured atmospheric pressure the processor 4 is able to determine the altitude difference between the radiotelephone 1 and the reference altitude. The processor 4 can determine the altitude by reference to a pressure/altitude table or with reference to Laplace law of atmospheres:

P=P₀e^{-MgA/RT}

where P₀ is the pressure at sea level, M is the average molar mass of the air, R is the ideal gas constant, T is the gas temperature and A is the altitude for a given atmospheric pressure P.

For altitudes between −1000 and 35332 feet this equation can be approximated to:

A=145375(1−(P/P₀)^{0 1923})

From this equation the radiotelephone 1 can determine the difference in altitude between the radiotelephone 1 and the reference altitude. Further, by adding the reference altitude, typically feet above sea level, to the difference in altitude, the radiotelephone 1 can determine the altitude of the radiotelephone 1 with respect to sea level.

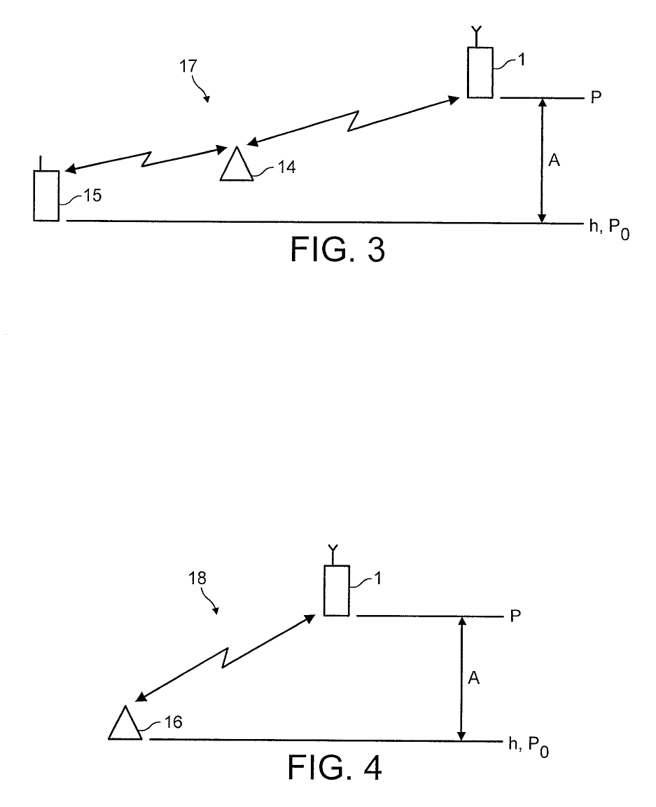

FIG. 3 shows a cellular communication system 17 having a basestation 14, radiotelephone 1 and radiotelephone 15, where radiotelephone 1 is as described above and is for use as an altimeter. Radiotelephone 15 is of similar design to radiotelephone 1, having an antenna, a transceiver, a processor, input means, a display and a pressure sensor (not shown). The basestation 14 is of conventional design, as is known to a person skilled in the art.

In operation radiotelephone 15 acts as a reference source and is located at a known altitude h. The altitude, typically feet above sea level, is input into the radiotelephone 15 via the input means (not shown), e.g. a keypad. The pressure sensor (not shown) measures the atmospheric pressure P₀ at this altitude.

To enable the reference data to be provided to radiotelephone 1 a connection is established between radiotelephone 1 and radiotelephone 15, via basestation 14, as is well known to a person skilled in the art. This connection may be initiated from either radiotelephone 1 or radiotelephone 15.

Once a connection has been established between radiotelephone 1 and radiotelephone 15 the reference altitude and atmospheric data is transmitted from radiotelephone 1 to radiotelephone 15. The data transfer can be either initiated by radiotelephone 1 or automatically transmitted by radiotelephone 15 once a connection has been established. If the data is automatically transmitted by radiotelephone 15 the data may be re-transmitted by radiotelephone 15 at regular intervals using updated atmospheric pressure data.

Typically the reference data is transmitted by radiotelephone 15 as a short message service (SMS) message, however the data can be transmitted in other data formats.

On receipt of the reference altitude and atmospheric pressure data the radiotelephone 1 calculates the altitude of the radiotelephone 1 as described above using the received reference data and the measured atmosphere pressure P and displays the calculated altitude to a user via display 13.

FIG. 4 shows a cellular communication system 18 having a basestation 16 and a radiotelephone 1, where radiotelephone 1 is as described above and is for use as an altimeter.

The basestation 16 has a transceiver and a pressure sensor, both of which are coupled to a processor (not shown). The processor controls the operation of the basestation 16 and has memory (not shown) for storing the altitude h, typically feet above sea level, of the basestation 16. The altitude of the basestation 16 is input into memory via input means (not shown). The pressure sensor (not shown) measures atmospheric pressure at the basestation 16.

The basestation 16 transmits the reference altitude and atmospheric pressure data to radiotelephone 1. The reference data can be transmitted as a broadcast message at regular intervals transmitting updated atmospheric pressure data in each broadcast message. This allows the radiotelephone 1 to acquire the reference data without having to establish a dedicated connection between the basestation 16 and the radiotelephone 1. Alternatively, the reference data can be transmitted to the radiotelephone 1 over a dedicated link between the basestation 16 and the radiotelephone 1, where the dedicated link would, typically, be initiated by radiotelephone 1.

On receipt of the reference altitude and atmospheric pressure data the radiotelephone 1 calculates the altitude of the radiotelephone 1 as described above using the received reference data and the measured pressure P and displays the calculated altitude to a user via display 13.

The present invention may include any novel feature or combination of features disclosed herein either explicitly or implicitly or any generalisation thereof irrespective of whether or not it relates to the present claimed invention or mitigates any or all of the problems addressed. In view of the foregoing description it will be evident to a person skilled in the art that various modifications may be made within the scope of the invention, for example cellular systems other than GSM may be used.

What is claimed is:

1. A communication handset comprising a receiver for receiving a RF signal incorporating reference altitude and associated atmospheric pressure data; a pressure sensor for measuring atmospheric pressure and processing means for determining from the received atmospheric pressure data and measured atmospheric pressure the difference in altitude between the handset and the reference altitude.

2. A communication handset according to claim 1, wherein the processing means determines the altitude of the handset from the received reference altitude and the difference in altitude between the handset and reference altitude.

3. A communication handset according to claim 1 or 2, wherein the altitude and pressure data is received via a short messages service message.

4. A communication handset according to any preceding claim, further comprises means for requesting the reference altitude and associated atmospheric data.

5. A cellular communication system comprising a transmitter for transmitting reference altitude and associated atmospheric pressure data and a communication handset according to any of the preceding claims.

6. A cellular communication system according to claim 5, wherein the transmitter is a communication handset at a known altitude with a pressure sensor for measuring atmospheric pressure.

7. A cellular communication system according to claim 5, wherein the transmitter is a basestation at a known altitude with a pressure sensor for measuring atmospheric pressure.

8. A communication handset substantially as hereinbefore described with reference to the accompanying drawings, and/or as shown therein.

9. A cellular communication system substantially as hereinbefore described with reference to the accompanying FIG. 3 or 4, and/or as shown therein.
